(19) United States
(12) Patent Application Publication
(10) Pub. No.: US 2013/0299065 A1
(43) Pub. Date: Nov. 14, 2013

(54) REPAIR PATCH FOR RADIAL TIRES

(71) Applicants: Rodney R. Bailey, Simpsonville, SC (US); Cesar Enrique Zarak, Simpsonville, SC (US)

(72) Inventors: Rodney R. Bailey, Simpsonville, SC (US); Cesar Enrique Zarak, Simpsonville, SC (US)

(73) Assignees: MICHELIN RECHERCHE ET TECHNIQUE S.A., Granges-Paccot (CH); COMPAGNIE GENERALE DES ETABLISSEMENTS MICHELIN, Clermont-Ferrand (FR)

(21) Appl. No.: 13/944,661

(22) Filed: Jul. 17, 2013

Related U.S. Application Data
(62) Division of application No. 12/741,380, filed on May 5, 2010.

(51) Int. Cl. B29C 73/10

(52) U.S. Cl. CPC B29C 73/10
USPC 156/95

(57) ABSTRACT

A repair patch for repairing radial tires that reduces the size of a bulge as typically appears in the sidewall of a repaired radial tire. The patch includes a ply package having a first reinforcement ply and a second reinforcement ply superimposed on the first reinforcement ply. The first reinforcement ply package comprises a tissue of first reinforcement cords that are arranged in a radial direction while the second reinforcement play comprises a tissue of second reinforcement cords that are arranged essentially in a 0 degrees direction. The patch of particular embodiments may further include a top cushion gum layer and a bottom cushion gum layer, wherein the ply package is interposed between the top and bottom cushion gum layers.

Also included are methods for using the repair patch to repair radial tires.

### BACKGROUND OF THE INVENTION

1. Field of the Invention

This invention relates generally to tire repairs and more specifically, to reinforced patches useful for repairing a damaged radial tire.

2. Description of the Related Art

Tire repair is an important part of maintaining the performance and value of modern tires, especially truck tires and off the road tires. The materials that are typically used to repair tires include rubber compounds, reinforced and non-reinforced rubber patches, rubber plugs, cements, cold vulcanizing fluids, chemical cleaners and sealers.

Reinforced tire repair patches are known to consist typically of cured layers of rubber compounds, reinforcements and often a thin layer of uncured rubber for bonding to the inner liner of the tire. Such a patch is disclosed in U.S. Pat. No. 4,285,382, the disclosed patch having overlapping plies of reinforcing cords, a base cushion gum layer and an intermediate cushion gum layer positioned between at least two of the plies.

U.S. Pat. No. 4,399,854 discloses a patch for repairing a tire having at least one ply package enveloped by an unvulcanized base cushion gum layer and an unvulcanized top cushion gum layer joined at the edges of the ply package. A patch that is disclosed as useful for repairing bias ply tires includes reinforcing cords that are made of nylon or alternatively, made of polyester, polyamides or wire. The ply package includes overlapping plies of the reinforcing cords, the plies being in a criss-cross relationship with the cords of the adjacent plies positioned at substantially right angles. However, a patch that is disclosed as useful for repairing radial tires includes a ply package made up of overlapping plies of reinforcing cords that extend in substantially the same direction.

Repairs of radial tires using reinforced patches have been used for years and are known to be safe. However, one problem that is merely a perceived problem associated with radial tire repairs is that such repairs often include a bulge in the sidewall of the tire. To highway patrol officers and weigh station inspectors, these bulges may be perceived as an indication of a separation in the sidewall, resulting in a requirement to change the tire to one having no bulge.

Therefore, it would be an advantage to provide a reinforced patch for radial tires that reduces or eliminates the bulge on the sidewall of the tire after a repair.

### SUMMARY OF THE INVENTION

Embodiments of the present invention include patches for repairing radial tires and methods for their use in repairing damaged radial tires. Particular embodiments of patches for repairing radial tires include a ply package having a first reinforcement ply and a second reinforcement ply superimposed on the first reinforcement ply. The first reinforcement ply package comprises a tissue of first reinforcement cords that are arranged in a radial direction while the second reinforcement play comprises a tissue of second reinforcement cords that are arranged essentially in a 0 degrees direction.

The patch of particular embodiments may further include a top cushion gum layer and a bottom cushion gum layer, wherein the ply package is interposed between the top and bottom cushion gum layers.

Particular embodiments of the present invention further include methods for repairing a radial tire, such methods including the steps of covering a damaged area of the radial tire with the patch described above and bonding the patch to the radial tire.

The foregoing and other objects, features and advantages of the invention will be apparent from the following more detailed descriptions of particular embodiments of the invention, as illustrated in the accompanying drawing wherein like reference numbers represent like parts of the invention.

### BRIEF DESCRIPTION OF THE DRAWINGS

FIG. 1 is a partial cut away top view of an exemplary radial tire repair patch in accordance with the present invention.

FIG. 2 is a top view of the ply package of the exemplary patch of FIG. 1.

FIG. 3 is a cross sectional view of the exemplary radial tire repair patch of FIG. 1.

FIG. 4 is a cross-sectional view of an exemplary radial tire repair patch having an intermediate rubber layer.

### DETAILED DESCRIPTION OF PARTICULAR EMBODIMENTS

The present invention provides, inter alia, radial tire repair patches and methods for their use. As such, the patches and methods for their use are not applicable for bias-ply tires according to embodiments of the present invention. The tire patches of particular embodiments of the present invention are useful for eliminating or reducing the bulge that typically appears on the outer surface of a radial tire that has been repaired with a patch. These patches are useful for radial tires, such radial tires including, for example, over the road radial tires for trucks, buses and so forth and off the road radial tires for earth movers, agricultural applications and so forth.

Known patches used in the industry to repair radial tires typically have one or more reinforcement plies comprising cords that are all arranged in essentially the radial direction, i.e., in the direction of the radial cords of the radial tire. The tires that are repaired with such patches often develop a bulge that is visible on the outer surface of the tire.

Particular embodiments of the present invention include patches that not only comprise one or more reinforcement plies having reinforcement cords that are arranged in the radial direction but also comprise one or more additional plies having reinforcement cords that are arranged essentially in the 0 degrees direction, i.e., that are arranged essentially orthogonally to the reinforcement cords arranged in the radial direction. Such arrangements of reinforcement plies have surprisingly shown a substantial decrease in the size of the bulge visible on the outer surface of a radial tire repaired with such patches.

Without delimiting the present invention, it is thought that the one or more reinforcement plies having reinforcement cords arranged in the radial direction provide the required reinforcement for the tire cords in the damaged area of the repaired radial tire while the one or more reinforcement plies having reinforcement cords arranged essentially in the 0 degrees direction reduce or eliminate the bulge associated with repaired radial tires.

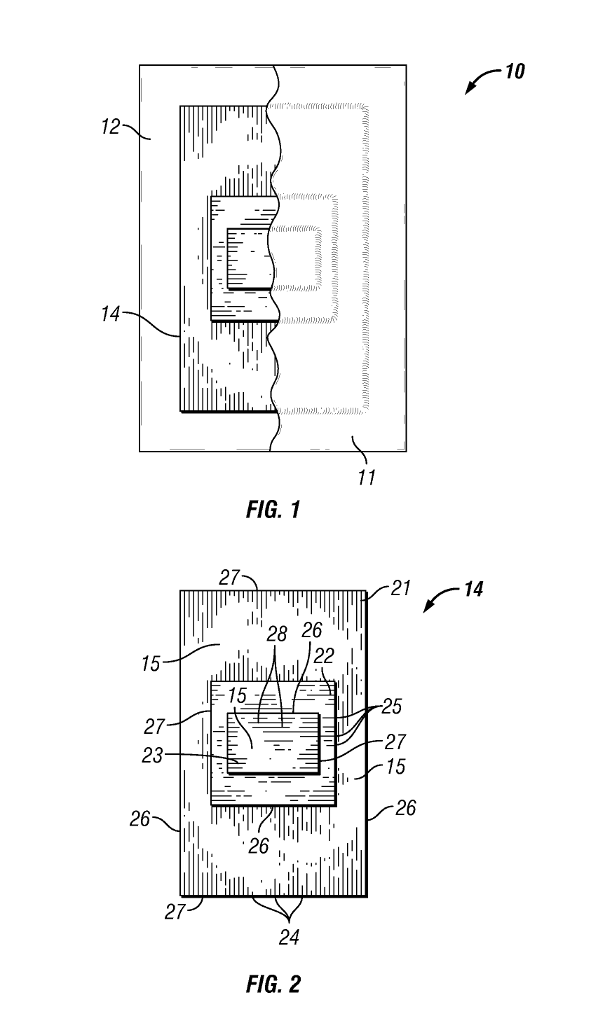

FIG. 1 is a partial cut away top view of an exemplary radial tire repair patch in accordance with the present invention. The patch 10 includes a reinforcement ply package 14 that is interposed between a top cushion gum layer 11 and a bottom cushion gum layer 12. The bottom cushion gum layer 12 of the patch 10 is typically bonded to an interior surface of a damaged radial tire during the repair process.

In particular embodiments of the patch, the bottom cushion gum layer 12 may comprise two separate layers—a first uncured bottom layer for bonding to the repaired tire and a second cured layer superimposed thereon. Each of these layers may have a thickness, for example, of between 0.2 and 1.5 mm.

The term “cushion gum” as used herein is a term defined as a layer or skim of a rubber composition. Without limitation, the cushion gum 11, 12 may be made of material that includes, for example, natural rubber, styrene butadiene rubber, polybutadiene or combinations thereof. The bottom 12 and top 11 cushion gum layers may be constructed of the same material or of different materials. The cushion gum may further include those materials known to one having ordinary skill in the art, such materials including, for example, one or more of the following: fillers such as carbon black, accelerators, curing agents, stearic acid, zinc oxide and anti-degradants.

In particular embodiments, the top 11 and bottom 12 cushion gum layers are each thicker than any one of the reinforcement plies 21, 22, 23 (FIG. 2) that make up the reinforcement ply package 14. These layers may have a thickness, for example, of between 0.5 and 5 mm or of between 0.8 and 3.5 mm. Both the bottom 12 and top 11 cushion gum layers extend beyond the sides of the reinforcement ply package 14.

FIG. 2 is a top view of the ply package of the exemplary patch of FIG. 1. The ply package 14 includes a first reinforcement ply 21 that is a tissue of first reinforcement cords 24. A tissue includes a plurality of reinforcements cords 24 coated with a skim of rubber coating 15. As known to those having ordinary skill in the art, the reinforcement cords 24 of a tissue may be coated with the rubber coating 15 by calendering the coating onto the plurality of reinforcement cords. The material used for the coating 15 may comprise, for example, natural rubber, styrene butadiene rubber, polybutadiene or combinations thereof although other materials may be used as appropriate for a given radial tire repair application.

The first reinforcement ply 21 includes ply ends 27 at those sides of the reinforcement ply 21 having the terminal ends of the first reinforcement cords 24 and ply edges 26 at the remaining sides of the reinforcement ply 21.

The reinforcement cords 24 of the first reinforcement ply 21 are arranged in a radial direction and, in the exemplary embodiment of FIG. 2, are mutually parallel. Alternatively, the reinforcement cords may be conforming, i.e., arranged to essentially conform to the “fan” shape of the radial cords in a radial tire, such shape being well known to one having ordinary skill in the art. Therefore, the term “cords arranged in the radial direction,” as used herein, is defined as cords that are arranged essentially in the same direction as the radial cords in a radial tire and therefore include both an arrangement of cords that are disposed mutually parallel one to the other having a longitudinal axis that is the same as the longitudinal axis of a radial cord of a radial tire on which the patch is to be applied and an arrangement of cords that are disposed in a conforming arrangement.

As disclosed above, particular embodiments of the present invention may include patches having additional reinforcement plies of reinforcement cords that are arranged in the radial direction. Each of the additional reinforcement plies is superimposed on the one below, thereby forming a “stack” of reinforcement plies. Particular embodiments include, though do not require, stacks of such reinforcement plies wherein each reinforcement ply is shorter (from end to end) and less wide (from edge to edge) than the reinforcement ply below it.

The ply package 14 further includes a second reinforcement ply 22 that is a tissue of second reinforcement cords 25. The reinforcement cords 25 are mutually parallel and extend towards the edges 26 of the first reinforcement ply 21 such that the second reinforcement cords 25 are arranged essentially in the 0 degrees direction, i.e., substantially orthogonal to the first reinforcement cords 24. Substantially orthogonal is meant to include angles that are within about 5 degrees of a 90 degree angle. In particular embodiments, the second reinforcement cords 25 form an angle with the first reinforcement cords 24 of about between 85 degrees and 95 degrees or alternatively, about between 88 degrees and 92 degrees or 90 degrees.

Typically, though not required, the second reinforcement ply 22 does not extend beyond the edges or the ends of the first reinforcement ply 21. In particular embodiments, the second reinforcement ply 22 may be centered over the center of the first reinforcement ply 21.

The ply package 14 may optionally include a third (or more, though not shown) reinforcement ply 23 that is a tissue of third reinforcement cords 28 superimposed on the second reinforcement ply 22. The second reinforcement cords 28 are arranged essentially in the 0 degrees direction and are typically parallel to the reinforcement cords 24 of the second reinforcement ply 22. Typically, though not required, the third reinforcement ply 23 does not extend beyond the edges or the ends of the second reinforcement ply 22. In particular embodiments, the third reinforcement ply 23 may be centered over the center of the second reinforcement ply 22.

The reinforcement plies having reinforcement cords that are arranged essentially in the 0 degrees direction (for example, the second 22 and third 23 reinforcement plies of FIG. 2) may, in particular embodiments, be sized to extend between 3 and 30 mm beyond the edges of the damaged area of the radial tire being repaired. Alternatively, the reinforcement plies may extend between 5 and 25 mm, between 7 and 15 mm or between 8 and 12 mm beyond the edges of the damaged area of the radial tire being repaired.

Typically at least one of the reinforcement plies having cords arranged essentially in the 0 degrees direction may extend at least between 2 and 15 mm or between 8 and 12 mm beyond the damaged area of the radial tire being repaired. In particular embodiments, all of the reinforcement plies having cords arranged essentially in the 0 degrees direction may extend beyond the damaged area of the radial tire being repaired.

Particular embodiments of patches having multiple reinforcement plies with cords arranged essentially in the 0 degrees direction, although not delimitative of the invention, may provide that each such ply have edges and ends that are no closer than between 2 and 10 mm or between 4 and 6 mm to the ends and/or edges of adjacent such plies.

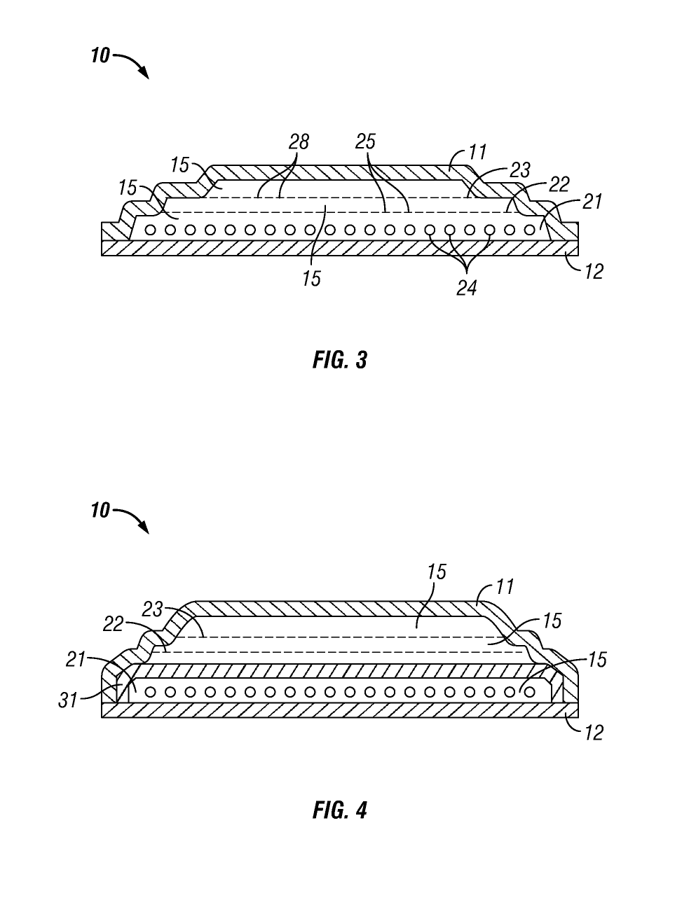

FIG. 3 is a cross sectional view of the exemplary patch of FIG. 1. The patch 10 is an embodiment having a ply package 14 that includes the first 21, second 22 and third 23 reinforcement plies, the first 21 ply having reinforcement cords 21 arranged in the radial direction and the second and third plies 22, 23 having cords 25, 28 arranged essentially in the 0 degrees direction.

Particular embodiments of the tire repair patch may further include an intermediate rubber layer between the reinforcement plies having cords arranged in the radial direction and the reinforcement plies having cords that are arranged essentially in the 0 degrees direction. Although not delimitative of the invention, the intermediate rubber layer may be about the same thickness as the bottom cushion gum layer and/or the top cushion gum layer. Optionally, the intermediate rubber layer may extend beyond the sides of the reinforcement ply package and extend, for example, to the edges of the upper and lower cushion gum layers.

Without limitation, the intermediate rubber layer may be made of the same materials as the top and/or bottom cushion gum layers or be of a different material. Typical materials of the intermediate rubber layer include, for example, natural rubber, styrene butadiene rubber, polybutadiene or combinations thereof.

FIG. 4 is a cross-sectional view of an exemplary radial tire repair patch having the intermediate rubber layer. The intermediate rubber layer 31 is disposed between the first reinforcement ply 21 having cords that are arranged in the radial direction and the second reinforcement ply 22 having cords that are arranged essentially in the 0 degrees direction. The thickness of the intermediate layer 31 shown in this exemplary embodiment is the same thickness as the bottom cushion gum layer 12.

The reinforcement cords such as those shown in FIGS. 1-3 may be made of materials having a high elastic modulus, a low elastic modulus or combinations thereof. The modulus of elasticity of a cord at a given stress or strain is defined as the extension secant modulus calculated at the given stress or strain. The units used herein to describe the stress on a cord or the modulus of elasticity for a cord is centiNewtons per tex (cN/tex) unless otherwise denoted.

As used herein, a cord having a high elastic modulus is one having an elastic modulus of at least 600 cN/tex at 20 cN/tex of stress. A cord having a low elastic modulus is one having an elastic modulus of less than 600 CN/tex at 20 cN/tex of stress. Such measurements are taken at 20° C. to determine whether a material is of high or low elastic modulus as defined herein. Examples of materials that may be used to manufacture cords having an elastic modulus of at least 600 cN/tex at 20 cN/tex of stress include steel, aramid and hybrids such as an aramid-nylon cord. Examples of materials that may be used to manufacture cords having an elastic modulus of less than 600 cN/tex at 20 cN/tex of stress include polyester and nylon.

The reinforcement plies making up the ply package may have cords of the same material or of different materials. Examples of suitable materials include, for example, steel, aramid, polyester, rayon, nylon or hybrids. In particular embodiments, the reinforcement cords of all of the reinforcement plies may be of the same material, such as aramid or polyester or nylon. In other embodiments, the cords of the reinforcement ply having cords arranged in the radial direction may be made of a first material, e.g., aramid, while the plies having cords arranged essentially in the 0 degrees direction may be made of a second material, e.g., nylon. In another exemplary embodiment, the cords of the reinforcement ply having cords arranged in the radial direction may be made of a first material, e.g., polyester, while the plies having cords arranged essentially in the 0 degrees direction may be made of a second material, e.g., nylon.

In particular embodiments, a patch of the present invention may include reinforcement plies having reinforcement cords arranged in the radial direction manufactured of a material characterized as having a modulus of elasticity that is at least 600 cN/tex at 20 cN/tex of stress and include reinforcement plies having cords arranged essentially in a 0 degrees direction manufactured of a material characterized as having a modulus of elasticity that is less than 600 cN/tex at 20 cN/tex of stress. Typically, although not delimitative, the cords arranged in the radial direction have a higher modulus of elasticity than the cords arranged essentially in the 0 degree direction.

The reinforcing cords making up the reinforcement plies may be arranged from 10-40 ends per inch and be, for example, of between 840 and 6000 denier. The tissues of cords may have a thickness, for example, of between 0.2 mm and 2 mm, between 0.25 and 1 mm or upwards to about 5 mm.

The methods for using particular embodiment of the patch according to the present invention are similar to those used for standard patches currently used in the industry. For example, a reinforced patch is typically applied to the inner liner of a radial tire after preparing the damaged area of the tire. The preparation consists of several steps that include, for example, at least some of the following steps: inspection of the damaged area of the tire, removal of material from and cleaning of the damaged area, cementing the hole, filling the hole with a rubber composition, surface preparation of the inner liner, application of a rubber cement or cushion gum, drying, application of the patch, stitching of the patch and curing of the patch and/or the repair area.

During the process of repairing a radial tire with a repair patch embodiment of the present invention, a repair patch of appropriate size is selected and placed over the damaged area of the radial tire. The repair patch is placed over the damaged area so that the reinforcement cords of the repair patch that are arranged in the radial direction (see, for example, FIG. 2) are positioned in the radial direction when the patch is applied to the sidewall of the tire. Furthermore, in particular embodiments, the patch is placed over the damaged area so that at least one or more of the reinforcement plies having cords arranged essentially in the 0 degrees direction extend beyond the boundaries of the damaged area.

While many of the patches of the present invention are rectangular in shape, the invention is not so limited. Particular embodiments may include patches that are, for example, round, hexagonal, trapezoidal or triangular as may be convenient for particular applications. The reinforcement plies that make up the patches of the present invention may assume the shape of the overall patch or may assume a different shape as may be convenient for particular applications.

The invention is further illustrated by the following examples, which are to be regarded only as illustrations and not delimitative of the invention in any way.

### Example 1

Patches having a reinforcement ply of cords arranged essentially in the 0 degrees direction were constructed and then used to repair a damaged area of a radial tire. The reduction in the bulge appearing on the outer surface of the repaired tires were compared with those on tires repaired with a witness patch having no cords arranged essentially in the 0 degree direction.

Tables 1 and 2 describe the construction of the witness patches and the Type A patches, which were similar to the witness patches except for the addition of a reinforcement ply having reinforcement cords arranged essentially in the 0 degrees direction.

TABLE 1
Witness Patch Construction

| Layer | Material | L × W × H (mm) |
|---|---|---|
| 1 | Butyl Rubber | 185 × 95 × 1 |
| 2 | NR-BR Blend | 170 × 84 × 1 |
| 3 | Aramid Radial | 125 × 68 × 1 |
| 4 | NR-BR Blend | 170 × 84 × 1 |
| 5 | Uncured Rubber | 190 × 105 × 1 |

TABLE 2
Type A Patches with 0 degrees Cords

| Layer | Material | L × W × H (mm) |
|---|---|---|
| 1 | Butyl Rubber | 185 × 95 × 1 |
| 2 | NR-BR Blend | 170 × 84 × 1 |
| 3 | Aramid 0 degrees | 95 × 40 × 1 |
| 4 | NR-BR Blend | 100 × 40 × 1 |
| 5 | Aramid Radial | 125 × 68 × 1 |
| 6 | NR-BR Blend | 170 × 84 × 1 |
| 7 | Uncured Rubber | 190 × 105 × 1 |

Each patch was assembled of layers that were each 1 mm thick. Each of the patches included a bottom cushion gum comprising a layer of uncured natural rubber for bonding the patch to the tire and a layer of cured rubber comprising a blend of natural rubber (NR) and butadiene rubber (BR). Each patch further included a top cushion gum comprising a top layer of inner liner material (butyl rubber) and a layer comprising the NR-BR blend.

The aramid tissues were made of aramid having two strands twisted at 315 turns per meter, each strand being 1500 denier. The cords were arranged at 106 cords per decimeter with the rubber thickness of the tissue being 0.38 mm.

The layers of the patch were arranged in the order shown in Tables 1 and 2, except for the uncured layer that was added after the rest of the patch was cured. The assembled patches were cured in membrane press (such as are available from Shaw-Almex Industries Ltd. of Canada) for nine minutes, with the press bottom plate maintained at 160° C. and the top membrane maintained at 175° C.

The patches were then applied to tires having a damaged area that was 25 mm wide and 70 mm long. The bulge that was visible on the outer surface of the repaired tire was then measured. Measurements of the bulge height above the sidewall surface were taken before the tires were inflated and then directly after the tires were inflated. The results are shown in Table 3.

TABLE 3
Bulge Measurements (mm)

| | Uninflated | Inflated | Difference | % of Standard |
|---|---|---|---|---|
| Witness 1 | 0.5 | 6.1 | 5.6 | 100 |
| Witness 2 | 1.4 | 6.85 | 5.45 | 100 |
| Type A 1 | 2.0 | 5.8 | 3.8 | 68 |
| Type A 2 | 2.3 | 6.4 | 4.1 | 75 |

As shown in Table 3, the patches having the reinforcement ply having cords that were arranged essentially in the 0 degrees direction had bulges visible on the sidewall that were significantly less than the bulges of the tires repaired with the convention patches.

The terms “comprising,” “including,” and “having,” as used in the claims and specification herein, shall be considered as indicating an open group that may include other elements not specified. The term “consisting essentially of,” as used in the claims and specification herein, shall be considered as indicating a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. The terms “at least one” and “one or more” are used interchangeably. The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of the invention. Ranges that are described as being “between a and b” are inclusive of the values for “a” and “b.”

It should be understood from the foregoing description that various modifications and changes may be made to the embodiments of the present invention without departing from its true spirit. The foregoing description is provided for the purpose of illustration only and should not be construed in a limiting sense. Only the language of the following claims should limit the scope of this invention.

1-18. (canceled)

19. A method for repairing a radial tire having radial cords, the method comprising:
covering a damaged area of the radial tire with a repair patch, the repair patch comprising a ply package including a first reinforcement ply comprising a tissue of first reinforcement cords, the first reinforcement cords arranged in a radial direction; a second reinforcement ply superimposed on the first reinforcement ply, the second reinforcement ply comprising a tissue of second reinforcement cords that are arranged essentially in a 0 degrees direction, wherein the 0 degrees direction is defined as being substantially orthogonal to the first reinforcement cords and wherein the radial direction is defined as being substantially alignable with the radial cords; and
aligning the first reinforcement cords to be substantially aligned with the radial cords.

20. The method of claim 19, wherein the first reinforcement cords are mutually parallel.

21. The method of claim 19, wherein the second reinforcement cords are mutually parallel extending towards edges of the first reinforcement ply, forming an angle of between 85 degrees and 95 degrees to the first reinforcement cords and wherein a length of the second reinforcement cords is less than a distance between the edges of the first reinforcement ply.

22. The method of claim 19, further comprising:
a top cushion gum layer and a bottom cushion gum layer, wherein the ply package is interposed between the top and bottom cushion gum layers.

23. The method of claim 19, wherein the first and second reinforcement plies are rectilinear.

24. The method of claim 19, wherein the second reinforcement ply is centered over a center of the first reinforcement ply.

25. The method of claim 19, further comprising:
a third reinforcement ply superimposed on the second reinforcement ply, the third reinforcement ply comprising a tissue of third reinforcement cords extending towards ends of the second reinforcement ply, the third reinforcing cords being arranged parallel to one another and to the second reinforcement cords.

26. The method of claim 25, wherein the third reinforcement cords have a length less than a distance between the ends of the second reinforcement ply.

27. The method of claim 26, wherein the second reinforcement cords are manufactured from a material characterized as having a modulus of elasticity less than 600 cN/tex at a stress of 20 cN/tex.

28. The method of claim 19, further comprising:
an intermediate rubber layer interposed between the first reinforcement ply and the second reinforcement ply.

29. The method of claim 19, wherein the intermediate rubber layer extends beyond edges of the first and second reinforcement plies.

30. The method of claim 19, wherein the first reinforcement cords are manufactured from a material characterized as having a modulus of elasticity of at least 600 cN/tex at a stress of 20 cN/tex.

31. The method of claim 30, wherein the first reinforcement cords are selected from steel or aramid.

32. The method of claim 19, wherein the second reinforcement cords are manufactured from a material characterized as having a modulus of elasticity less than 600 cN/tex at a stress of 20 cN/tex.

33. The method of claim 32, wherein the second reinforcement cords are selected from PET or nylon.

34. The method of claim 19, wherein the first and second reinforcement cords are manufactured from a material characterized as having a modulus of elasticity of at least 600 cN/tex at a stress of 20 cN/tex.

35. The method of claim 34, wherein the first and second reinforcement cords are manufactured from a material selected from steel or aramid.

36. The method of claim 19, further comprising:
bonding the patch to the radial tire.
